(19) United States
(12) Patent Application Publication
(10) Pub. No.: US 2016/0308294 A1
(43) Pub. Date: Oct. 20, 2016

(54) BOARD-TO-BOARD CONNECTOR GEOMETRIES

(71) Applicant: Apple Inc., Cupertino, CA (US)

(72) Inventors: Trent K. Do, Milpitas, CA (US); Brian S. Lau, Berkeley, CA (US); Robert Scritzky, Sunnyvale, CA (US); Aaron N. Miletich, San Jose, CA (US); George Tziviskos, Cupertino, CA (US); Makiko Kawamura Brzezinski, Santa Clara, CA (US)

(73) Assignee: Apple Inc., Cupertino, CA (US)

(21) Appl. No.: 15/194,134

(22) Filed: Jun. 27, 2016

Related U.S. Application Data
(60) Provisional application No. 62/185,017, filed on Jun. 26, 2015.

(51) Int. Cl. H01R 12/71; H01R 12/70

(52) U.S. Cl. CPC H01R 12/716; H01R 12/7005

(57) ABSTRACT

Board-to-board connectors are disclosed. The board to board connectors include a plurality of external connection structures, and a plurality of receptacle contacts. Each receptacle contact may be coupled to a corresponding external connection structure. Each receptacle contact may include an opening for receiving a plug contact for a corresponding plug side board-to-board connector, and an engaging feature where at least a portion of the engaging feature extends into a portion of the opening. The opening may have a receptacle alignment feature designed to correspond with a plug alignment feature on the plug side board-to-board connector.

### CROSS REFERENCE TO RELATED APPLICATIONS

The present application claims the benefit of U.S. Provisional Application No. 62/185,017, filed Jun. 26, 2015, which is hereby incorporated by reference for all purposes.

### BACKGROUND

Modern mobile devices, such as smart phones, laptops, tablets, and the like, have been increasing in popularity the last few years and improvements to these devices show no signs of stopping. An important aspect of modern mobile devices is their portability. Accordingly demand has increased for thinner, sleeker, and smaller sized mobile devices. As a result, a corresponding demand has increased for smaller, more compact device components that are used in such mobile devices.

For example, several types of boards, such as flexible circuit boards, printed circuit boards, and others, are often included in a single mobile device. These boards may be connected together using board-to-board connectors, which may consume valuable real estate inside a mobile device. Additionally, these boards may be connected and disconnected several times during its lifespan, thereby weakening the connection made by the board-to-board connectors. Thus, smaller-sized board-to-board connectors are needed to enable further size reduction of mobile devices.

### SUMMARY

Embodiments of the present invention provide board-to-board connectors that save space and have high cycling durability. In some embodiments, board-to-board connectors include a plug side connector and a receptacle side connector that can mate together to form an electrical connection. The plug side may include an array of plug contacts that insert into corresponding receptacle contacts in the receptacle side connector. Each plug contact and receptacle contact may be formed to have a unique profile configured to minimize footprint and maximize cycling durability.

In certain embodiments, a receptacle side board-to-board connector includes a plurality of external connection structures and a plurality of receptacle contacts. Each receptacle contact may be coupled to a corresponding external connection structure. Further, each receptacle contact may include an opening and an engaging feature. The opening may be for receiving a plug contact for a corresponding plug side board-to-board connector, and may have a receptacle alignment feature designed to correspond with a plug alignment feature on the plug side board-to-board connector. At least a portion of the engaging feature may extend into a portion of the opening.

In some embodiments, a plug side board-to-board connector includes a plurality of plug contacts. Each plug contact may have a plug alignment feature configured to align each plug contact with a corresponding receptacle alignment feature of a receptacle side board-to-board connector.

A better understanding of the nature and advantages of embodiments of the present invention may be gained with reference to the following detailed description and the accompanying drawings.

### BRIEF DESCRIPTION OF THE DRAWINGS

FIGS. 1A and 1B are simplified diagrams illustrating a mated board-to-board connector, in accordance with embodiments of the present invention.

FIGS. 2A-2C are simplified diagrams illustrating a board-to-board connector having a slot configuration, in accordance with embodiments of the present invention.

FIGS. 3A-3D are simplified diagrams illustrating a board-to-board connector having a slot configuration with deflection slots, in accordance with embodiments of the present invention.

FIGS. 4A-4C are simplified diagrams illustrating a board-to-board connector having a cantilever configuration where cantilevers are disposed on one side of a plug connector, in accordance with embodiments of the present invention.

FIGS. 5A-5C are simplified diagrams illustrating a board-to-board connector having a cantilever configuration where cantilevers are disposed on more than one side of a plug connector, in accordance with embodiments of the present invention.

FIGS. 6A-6C are simplified diagrams illustrating a board-to-board connector having a cantilever configuration where more than two cantilevers are utilized, in accordance with embodiments of the present invention.

FIGS. 7A-7D are simplified diagrams illustrating a board-to-board connector having a dual plug configuration, in accordance with embodiments of the present invention.

### DETAILED DESCRIPTION

Embodiments of the present invention relate to board-to-board connectors that have low profiles for minimizing footprint in an electronic device, and that have unique connector profiles for maximizing cycling durability. The board-to-board connectors may include plug side connectors and a receptacle side connectors that mate with one another to form electrical connections between two device boards. The structural design of both the plug side connector and the receptacle side connector may be configured to minimize overall board-to-board connector size as well as maximize cycling durability.

### I. Micro Array Connector

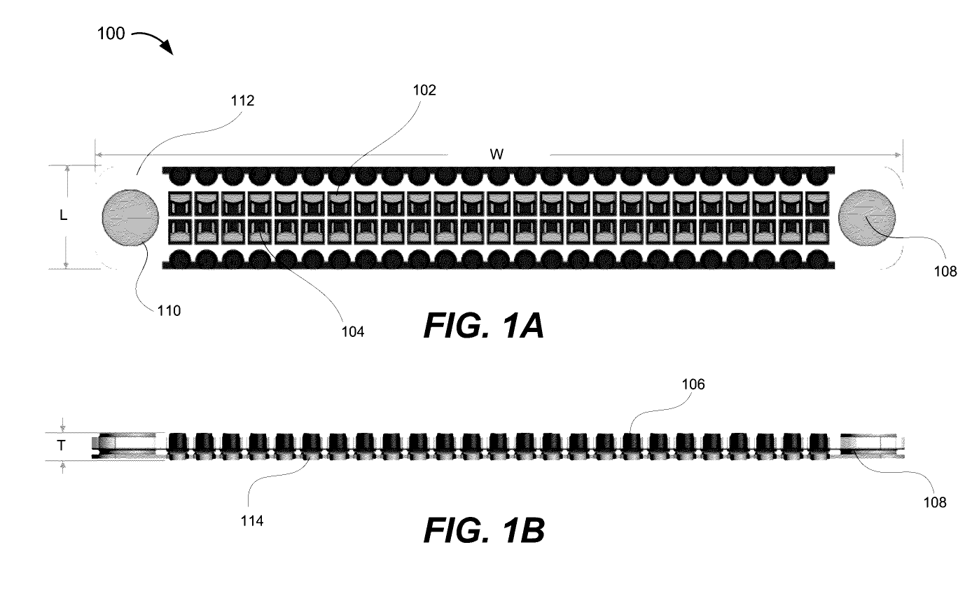

FIG. 1A illustrates a mated board-to-board connector 100 according to embodiments of the present invention. Mated board-to-board connector 100 may include a plug side board-to-board connector mated with a receptacle side board-to-board connector, both of which will be discussed in further detail herein. A plurality of plug contacts 102 may be physically and electrically connected to corresponding receptacle contacts 104 to form a robust connection between two circuit boards. Mated board-to-board connector 100 may also include a rough alignment structure 108 disposed within a rough alignment hole 110. Rough alignment structure 108 may protrude from the plug side board-to-board connector to provide rough alignment with the receptacle side board-to-board connector during mating. In embodiments, a stiffener 112 may be attached to the receptacle side board-to-board connector to provide structural support during handling and/or use.

Each plug contact 102 and receptacle contact 104 may be electrically coupled to a respective external connection structure. External connection structures allow each plug contact 102 and receptacle contact 104 to make electrical connection with external devices via external connection methods, such as via a wire soldered onto the external connection structures. A better view of the external structures is illustrated in FIG. 1B.

FIG. 1B illustrates a side-view perspective of a board-to-board connector 100. Plug contacts 102 in FIG. 1A may be coupled to respective external plug connection structures 106, and receptacle contacts 104 in FIG. 1A may be coupled to respective external receptacle connection structures 114. In embodiments, each plug contact 102 and corresponding external connection structure 106 may be one monolithic structure, or formed of two different structures coupled together in alternative embodiments. In embodiments, the overall thickness T may range between 0.25 to 0.45 mm.

With reference back to FIG. 1A, a contact pitch of plug contacts 102 may be smaller than conventional contact pitches. As an example, plug contacts 102 may have a pitch ranging between 0.2 to 0.39 mm when conventional plug contacts may only be able to achieve a minimum plug contact pitch of 0.4 mm. Smaller plug contact pitches enables formation of smaller overall board-to-board connector size. Thus, board-to-board connector 100 according to embodiments herein may be smaller than conventional board-to-board contacts. For instance, board-to-board connector 100 may have a width W between 9.00 and 11.00 mm and a length L between 1.00 and 1.50 mm when conventional board-to-board connectors may only achieve a minimum width of 11.70 mm and a minimum length of 1.50 mm. The unique structure of the receptacle contacts 104 and plug contacts 102, as will be discussed further herein, enable the small contact pitches of the board-to-board connector 100 and maximize cycling durability.

### II. Arrangements of Board-to-Board Connectors

Embodiments of the present invention include various structural configurations for the plug contacts and the receptacle contacts. The different structural configurations allow for smaller contact pitches as well as lower connector profiles such that the overall board-to-board connector size can be decreased. Additionally, the different structural configurations enable the board-to-board connector to have higher cycling durability. A connector having higher cycling durability can withstand a greater number of disconnections and reconnections between the plug side and receptacle side of the board-to-board connector. Furthermore, the different structural configurations may also allow the board-to-board connector to be mated by various methods, such as by hand or an object, such as a screw, a clamp, and the like.

With the following description, the different structural configurations will be discussed in further detail. It is to be appreciated that the following figures discussed herein illustrate only two sets of contacts; however, one skilled in the art understands that more or less than two sets of contacts may be utilized in a board-to-board connector. Furthermore, the two sets of contacts may form two separate electrical connections, or may be coupled together to form one single electrical connection.
A. Single Plug Configuration

One type of configuration is a single plug configuration. The single plug configuration refers to a plug contact that is formed of a single plug. That is, a single plug is coupled to a corresponding external connection structure for mating electrical and physical connections to a corresponding receptacle. The single plug contact may mate with a corresponding receptacle that has structural features designed to complement the single plug contact. In embodiments, utilizing a single plug configuration not only enables the benefits discussed herein, but may also simplify manufacturing and design.
1. Slot Configuration

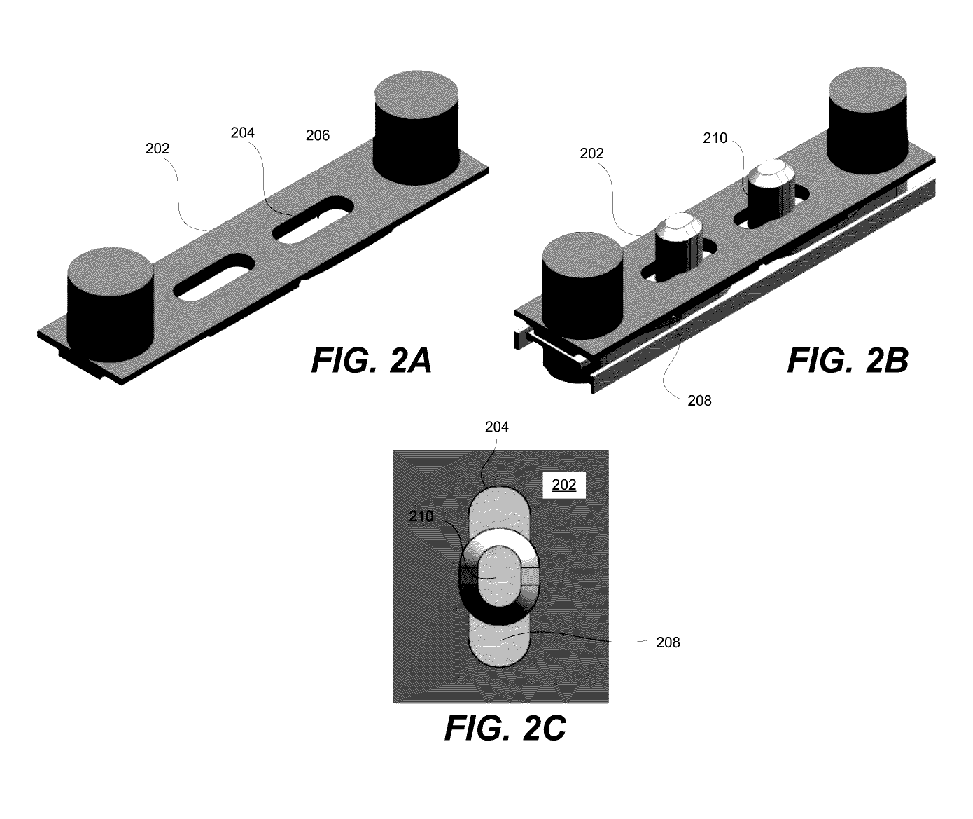

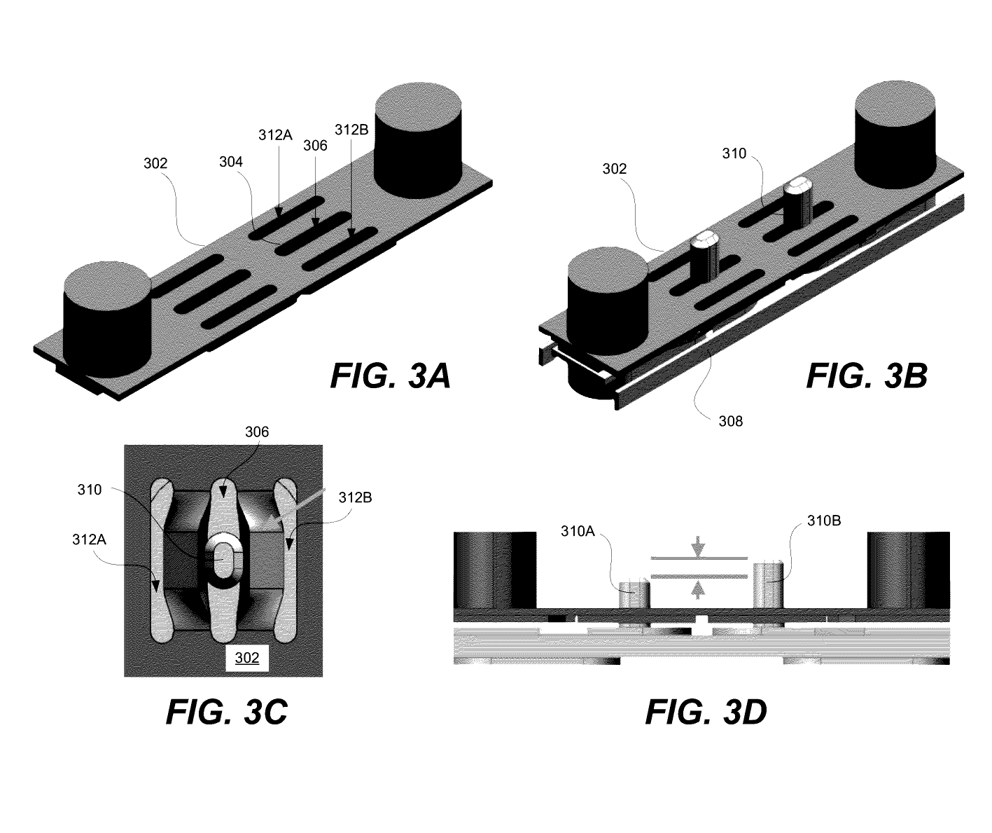

One type of receptacle contact designed to mate with single plug contacts is a receptacle contact that has a slot configuration. FIGS. 2A-2C illustrate structural features of a receptacle contact having such a slot configuration. Specifically, FIG. 2A illustrates a perspective view of an exemplary receptacle side board-to-board connector 202 having a slot configuration, FIG. 2B illustrates a perspective view of the exemplary receptacle side board-to-board connector 202 mated with a corresponding plug side board-to-board connector 208, and FIG. 3C illustrates a close-up top view perspective of the mated contact.

As shown in FIG. 2A, receptacle contact 204 may be formed of an insertion slot 206. Insertion slot 206 may couple with a corresponding plug contact 210 (see FIG. 2B) of a plug side board-to-board connector 208. In embodiments, insertion slot 206 may be an elongated opening that has a length greater than its width. This elongated arrangement may allow the corresponding plug contact 210 to be inserted precisely in the direction along the width but imprecisely in the direction along the length. Thus, a corresponding plug contact may mate with receptacle contact 204 without having to be precisely aligned in both directions. This makes it easier for mating to occur, and makes it easier to manufacture, thereby decreasing manufacturing cost. In some embodiments, plug contact 210 may have beveled top edges to help guide plug contact 210 into insertion slot 206.

In certain embodiments, the width of plug contact 210 may be slightly greater than the corresponding width of receptacle contact 204 so that when mated, plug contact 210 may snugly fit within opening 210, as shown in FIG. 2C. Frictional force between receptacle contact 204 and plug contact 210 may secure both contacts 204 and 210 together to prevent inadvertent separation. The length of plug contact 210 may be less than the length of receptacle contact 204 such that plug contact 210 may mate with receptacle contact 204 even if off-center from the center of insertion slot 206 in the direction along their lengths. In embodiments, length of receptacle contact 204 may be at least two times greater than the length of plug contact 210.

In embodiments, the slot configuration can be modified to enhance cycling durability. For instance, the slot configuration can be modified to include deflection slots. FIGS. 3A-3D illustrate structural features of a receptacle contact having such a modified slot configuration. Specifically, FIG. 3A illustrates a perspective view of an exemplary receptacle side board-to-board connector 302 having a modified slot configuration, FIG. 3B illustrates a perspective view of the exemplary receptacle side board-to-board connector 302 mated with a corresponding plug side board-to-board connector 308, FIG. 3C illustrates a close-up top view perspective of the mated contact, and FIG. 3D illustrates a side-view perspective of the mated contact.

As shown in FIG. 3A, receptacle contact 304 may be formed of an insertion slot 306 and a pair of deflection slots 312A and 312B. Insertion slot 306 may be similar to insertion slot 206 discussed herein with respect to FIGS. 2A-2C, and allow a corresponding plug contact 310 (see FIG. 2B) of a plug side board-to-board connector 308 to be inserted precisely in the direction along the width but imprecisely in the direction along the length. In embodiments, deflection slots 312A and 312B may be disposed on opposite sides of the insertion slot 316. Deflection slots 312A and 312B allow portions of receptacle contact 304 to disposed between the insertion slot 206 and deflection slots 312A and 312B to bend (or “deflect”) into the deflection slots 312A and 312B, as better illustrated in FIG. 3C.

In such embodiments, the width of plug contact 310 may be more than slightly greater than the corresponding width of receptacle contact 204 so that when mated, plug contact 310 may snugly fit within opening 310 by deflecting portions of receptacle contact 304 into deflection slots 312A and 312B. Similar to the slot configuration discussed above in FIGS. 2A-2C, frictional force between receptacle contact 304 and plug contact 310 may secure them together to prevent inadvertent separation. In embodiments, allowing portions of receptacle contact 304 to deflect into deflection slots 312A and 312B increases cycling durability due to the greater elasticity of the deflecting portions than without deflection slots 312A and 312B.

In addition to modifications to receptacle side board-to-board connectors 302, modifications to plug side board-to-board connectors 308 may be made as well. Modifications to the plug side board-to-board connectors 308 may include modifying the height of plug contacts 310. For instance, plug contacts 310 may have different heights. As shown in FIG. 3D, a first plug contact 310A may have a different height than an adjacent plug contact, such as a second plug contact 310B. Having different heights may assist in decreasing the insertion force necessary to mate the connectors 302 and 308. The taller plug contact, e.g., second plug contact 310B, may insert into respective insertion slot 304 first before the shorter plug contact, e.g., first plug contact 310A, inserts into respective insertion slot 304. Accordingly, the total amount of force required to mate the two connectors 302 and 308 may be split into two separate instances, where each instance requires less insertion force than a single instance where all the plugs are inserted at the same time (i.e., in the case where the plug heights are the same). Thus, less insertion force may be required to mate the connectors 302 and 308 with one another.
2. Engagement Feature Configuration

Another type of receptacle contact designed to mate with single plug contacts is a receptacle contact that has engagement features. Engagement features may be a structure of a receptacle contact that engages with a corresponding plug contact during mating by bending or deforming. When mated, the engagement features may be bent to make contact with the plug contact. In embodiments, the engagement feature may be a cantilever beam, thereby forming a cantilever beam configuration. In contrast to the slot configuration, the cantilever beam configuration can be arranged to allow accurate alignment between the plug contact and receptacle contact by utilizing alignment features. Additionally, portions of the receptacle contact may deflect upwards when the plug contact mates with the receptacle contact, thereby increasing cycling durability. These structural features are discussed in further detail in the following exemplary embodiments.

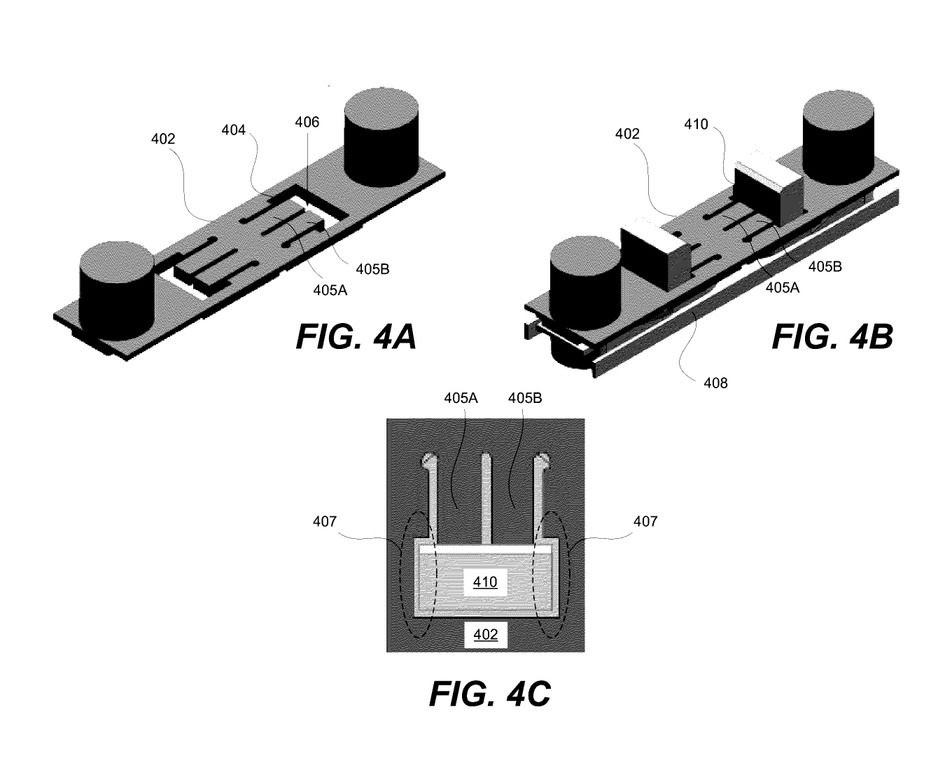

FIGS. 4A-4C illustrate structural features of a receptacle contact having such a cantilever beam configuration. Specifically, FIG. 4A illustrates a perspective view of an exemplary receptacle side board-to-board connector 402 having a cantilever beam configuration, FIG. 4B illustrates a perspective view of the exemplary receptacle side board-to-board connector 402 mated with a corresponding plug side board-to-board connector 408, and FIG. 4C illustrates a close-up top view perspective of the mated contact.

As illustrated in FIG. 4A, receptacle contact 404 may be formed of an opening 406 and a pair of cantilevers 405A and 405B. Opening 406 may be may be an opening within receptacle side board-to-board connector 402 that allows a corresponding plug contact 410 (see FIG. 4B) of a plug side board-to-board connector 408 to be inserted to establish an electrical and physical connection. In some embodiments, plug contact 410 may have beveled top edges to help guide plug contact 410 into opening 406. Surfaces of plug contact 410 that make contact with edges of engagement features, i.e., cantilevers 405A and 405B, may be designed to complement the edges of the engagement features such that there may be a solid physical connection between them when mated. For instance, as shown in FIG. 4C, edges of the plug contact 410 as well as corresponding edges of cantilevers 405A and 405B may be substantially planar such that contact may be made across the entire contact interface.

In certain embodiments, cantilevers 405A and 405B may extend into a portion of opening 406 so that when mated, cantilevers 405A and 405B may bend toward the direction of insertion, e.g. upward. Accordingly, plug contact 410 may snugly fit within opening 406, as shown in FIG. 4C. A counteracting force from the bent cantilevers 405A and 405B applied against a side of the plug contact 410 may secure them together to prevent inadvertent separation. In embodiments, allowing cantilevers 405A and 405B to bend when mated increases cycling durability due to the elasticity of the cantilevers 405A and 405B.

In embodiments, receptacle contact 404 may have alignment features 407 for assisting in fine alignment with plug contact 410 during mating. Alignment features 407 may be unique edges of opening 406 that only allows a complementary alignment feature to insert into opening 406. For instance, alignment features 407 may have a may have angular profiles designed to complement a corresponding plug alignment feature of plug contact 410. The plug alignment feature may be regions of plug contact 410 that complement alignment features 407, such as the four corners of plug contact 410. When mated, plug contact 410 may thus be accurately aligned with receptacle contact 404.

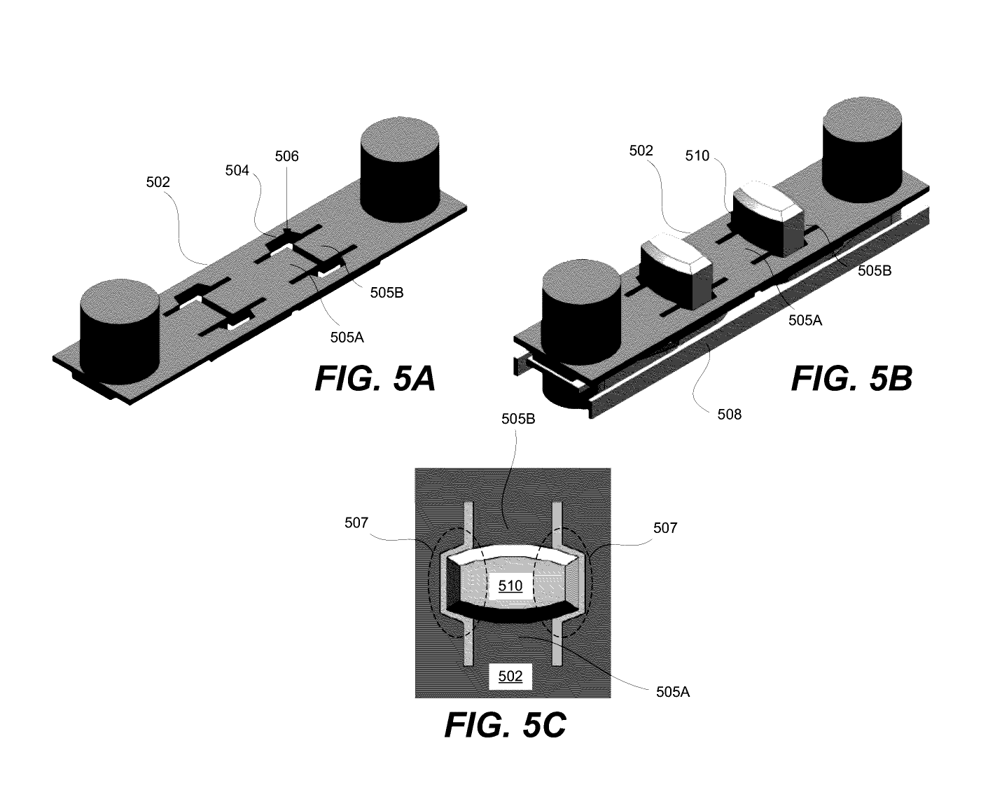

Although FIGS. 4A-4C illustrate engaging features, e.g. cantilevers 405A and 405B, making contact with only one side of plug contact 410, embodiments are not so limited. For instance, engaging features may contact more than one side of a plug contact, as shown in FIGS. 5A-5C.

FIGS. 5A-5C illustrate structural features of a receptacle contact having a cantilever beam configuration where cantilevers are disposed on opposite sides of a plug contact. Particularly, FIG. 5A illustrates a perspective view of an exemplary receptacle side board-to-board connector 502 having a two-sided cantilever beam configuration, FIG. 5B illustrates a perspective view of the exemplary receptacle side board-to-board connector 502 mated with a corresponding plug side board-to-board connector 508, and FIG. 5C illustrates a close-up top view perspective of the mated contact.

As illustrated in FIG. 5A, receptacle contact 504 may be formed of an opening 506 and a pair of cantilevers 505A and 505B on opposite sides of opening 506. Opening 506 may be may be an opening within receptacle side board-to-board connector 502 that allows a corresponding plug contact 510 (see FIG. 5B) of a plug side board-to-board connector 508 to be inserted to establish an electrical and physical connection. In some embodiments, plug contact 510 may have beveled top edges to help guide plug contact 510 into opening 506.

Surfaces of plug contact 510 that make contact with edges of engagement features, i.e., cantilevers 505A and 505B, may be designed to complement one another such that there may be a solid physical connection between them when mated. For instance, as shown in FIG. 5C, edges of the plug contact 510 as well as corresponding edges of cantilevers 505A and 505B may be curved such that contact may be made across the entire contact interface. One surface may have a concave profile and the other surface may have a complementary convex profile to allow contacting across the entire interface.

Alignment features 507 may also be arranged such that fine alignment is made between plug contact 510 and receptacle contact 504. As shown in FIG. 5C, alignment features 507 may have curved edges that complement the curved edges of plug contact 510. Similar to the cantilevers 405A and 405B discussed in FIGS. 4A-4C, cantilevers 505A and 505B may extend into a portion of opening 506 so that cantilevers 505A and 505B bend toward the direction of insertion, e.g. upward, when mated.

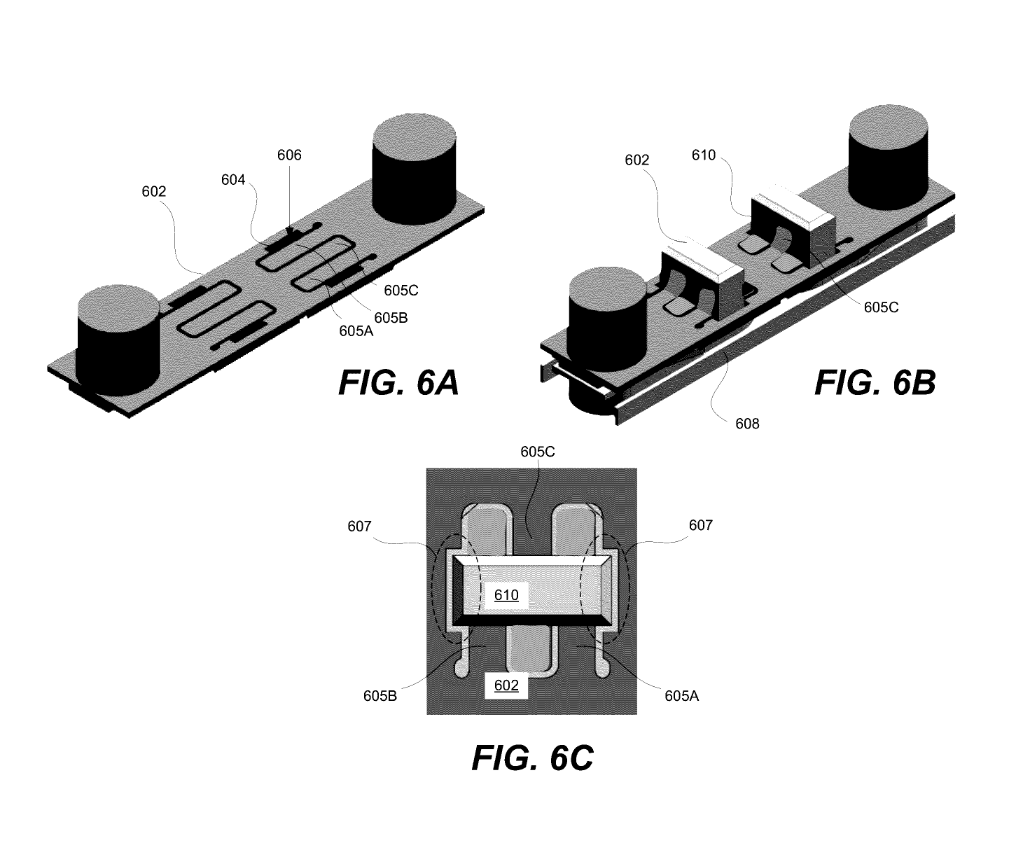

Although FIGS. 4A-4C and 5A-5C illustrate two cantilevers as engaging features, more or less cantilevers may be utilized as engaging features in other embodiments. For instance, engaging features may include three cantilevers as shown in FIGS. 6A-6C.

FIGS. 6A-6C illustrate structural features of a receptacle contact having a cantilever beam configuration where more than two cantilevers are utilized to contact a plug contact. Specifically, FIG. 6A illustrates a perspective view of an exemplary receptacle side board-to-board connector 602 having a cantilever beam configuration utilizing three cantilevers, FIG. 6B illustrates a perspective view of the exemplary receptacle side board-to-board connector 602 mated with a corresponding plug side board-to-board connector 608, and FIG. 6C illustrates a close-up top view perspective of the mated contact.

As shown in FIG. 6A, receptacle contact 604 may be formed of an opening 606 and cantilevers 605A, 605B, and 605C. Opening 606 may be may be an opening within receptacle side board-to-board connector 602 that allows a corresponding plug contact 610 (see FIG. 5B) of a plug side board-to-board connector 608 to be inserted to establish an electrical and physical connection. In some embodiments, plug contact 610 may have beveled top edges to help guide plug contact 610 into opening 606. Surfaces of plug contact 610 that make contact with edges of engagement features, i.e., cantilevers 605A and 605B, may be designed to complement one another such that there may be a solid physical connection between them when mated. Alignment features 607 may be formed within the receptacle contact 604 to help with alignment of plug 610 when mating.

Although FIGS. 6A-6C illustrate two cantilevers 605A and 605B on one side of opening 606 while cantilever 605C is on an opposite side, other cantilever arrangements are envisioned herein. For instance, other embodiments may have all three cantilevers disposed on one side of opening 606. Additionally, other embodiments may have more than three cantilevers with different cantilever arrangements. As an example, other embodiments may have four cantilevers with two on each side of opening 606. Having more cantilevers increases cycling durability because if one cantilever fails, there are several others that are able to make contact with a corresponding plug contact.
B. Dual Plug Configuration

In addition to having single plug configurations as aforementioned herein, other embodiments may have configurations that include more than one plug. For instance, plug side board-to-board connectors may have a dual plug configuration. The dual plug configuration refers to a plug contact that is formed of two plug structures. That is, two plug structures are coupled to a corresponding external connection structure. The dual plug contact may mate with a corresponding receptacle contact that has structural features designed to complement the dual plug contact. In embodiments, utilizing a dual plug configuration may further increase cycling durability by providing two avenues through which connections can be made.

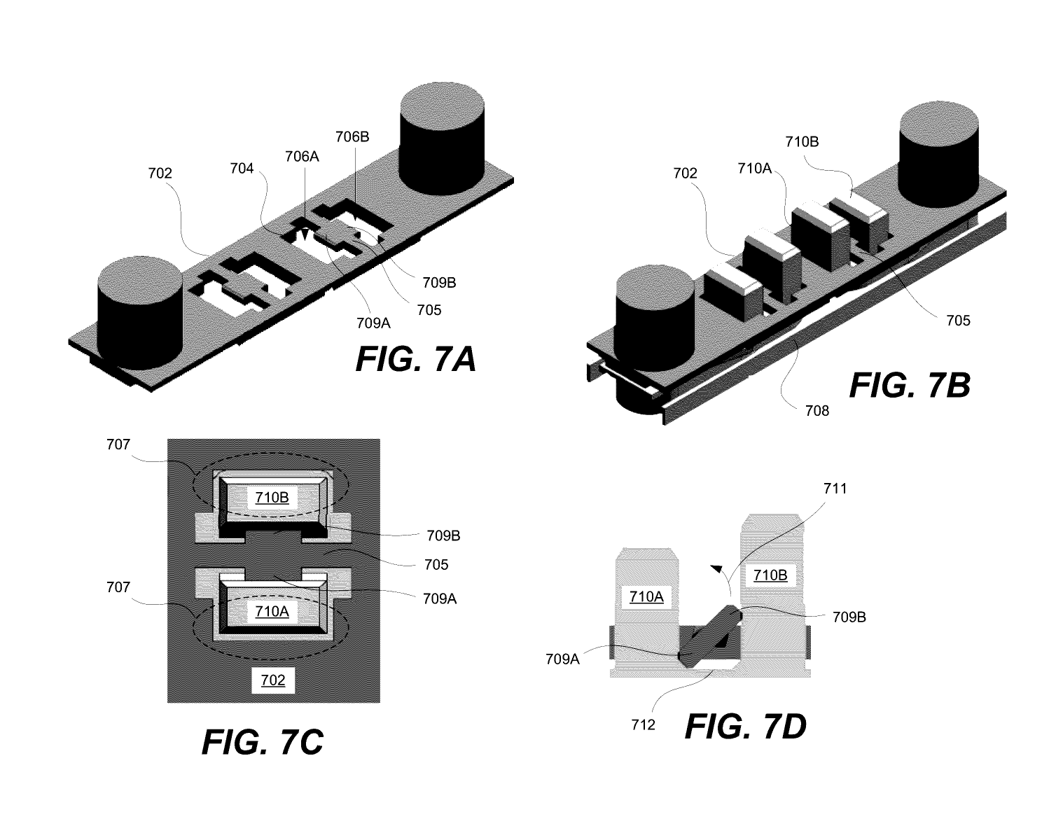

FIGS. 7A-7D illustrate structural features of a receptacle contact designed to mate with such a dual plug configuration. Specifically, FIG. 7A illustrates a perspective view of an exemplary receptacle side board-to-board connector 702 having a twisting engagement feature configuration, FIG. 7B illustrates a perspective view of the exemplary receptacle side board-to-board connector 702 mated with a corresponding plug side board-to-board connector 708 having dual plug structures, FIG. 7C illustrates a close-up top view perspective of the mated contact, and FIG. 7D illustrates a side-view perspective of the mated contact.

As illustrated in FIG. 7A, receptacle contact 704 may be formed of two openings 406A and 406B, and a twisting engagement feature 705. Openings 706 may be may be openings within receptacle side board-to-board connector 402 that allow a corresponding dual plug contact 710 (see FIG. 7B) of a plug side board-to-board connector 708 to be inserted to establish an electrical and physical connection. Dual plug contact 710 may include two plug structures: first plug structure 710A and second plug structure 710B. In some embodiments, plug contact 710 may have beveled top edges to help guide plug contact 710 into openings 706A and 706B.

In embodiments, twisting engagement feature 705 may have protrusions 709A and 709B that make contact with surfaces of plug contact 710 when mated as shown in FIG. 7A. Surfaces of plug contact 710 that make contact with edges of protrusions 709A and 709B may be designed to complement one another such that there may be a solid physical connection between them when mated. For instance, as shown in FIG. 7C, edges of the plug contact 710A and 710B as well as corresponding edges of protrusions 709A and 709B may be substantially planar such that contact may be made across the entire contact interface.

In certain embodiments, protrusions 709A and 709B may extend into a portion of openings 406A and 706B, respectively, so that twisting engagement feature 705 may twist when protrusions 709A and 709B make contact with plug structures 710A and 710B. Accordingly, plug contact 710 may snugly fit within openings 706A and 706B, as shown in FIG. 7C. A counteracting force from the twisted twisting engagement feature 705 may secure plug contact 710 in place to prevent inadvertent separation.

In embodiments, receptacle contact 704 may have alignment features 707 for assisting in fine alignment with plug contact 710 during mating. Alignment features 707 may be unique edges of openings 706A and 706B that only allow a complementary alignment feature to insert into openings 706A and 706B. For instance, plug contact 710 may have a rectangular structure designed to complement alignment features 707. When mated, plug contact 710 may be accurately aligned with receptacle contact 704.

In FIG. 7D, first and second plug structures 710A and 710B may be one monolithic structure having a bridging region 712, or may be coupled to one another by a separate structure.

Thus, first and second plug structures 710A and 710B may form one plug contact 710 having a dual-plug configuration.

As further illustrated in FIG. 7D, first and second plug structures 710A and 710B may have different heights. Having different heights allows the twisting engagement feature 705 to consistently twist in the same direction. The taller plug structure may contact a respective protrusion to initiate twisting of the engagement feature 705, resulting in a twisting motion. For instance, as shown in FIG. 7D, second plug structure 710B may have a larger height than first plug structure 710A. Accordingly, protrusion 709B may initially contact second plug structure 710B, thereby initiating a counterclockwise twisting motion 711. As plug 710 is inserted further into opening 706, first protrusion 709A may subsequently make contact with first plug structure 710A. In embodiments, allowing twisting engagement feature 705 to twist when mated increases cycling durability due to the elasticity of the twisting engagement feature 705.

Although the invention has been described with respect to specific embodiments, it will be appreciated that the invention is intended to cover all modifications and equivalents within the scope of the following claims.

What is claimed is:

1. A receptacle side board-to-board connector comprising:
a plurality of external connection structures; and
a plurality of receptacle contacts, each receptacle contact coupled to a corresponding external connection structure, each receptacle contact comprising:
an opening for receiving a plug contact for a corresponding plug side board-to-board connector, the opening having a receptacle alignment feature designed to correspond with a plug alignment feature on the plug side board-to-board connector; and
an engaging feature wherein at least a portion of the engaging feature extends into a portion of the opening.

2. The connector of claim 1 wherein the engaging feature comprises one or more cantilever beams.

3. The connector of claim 2 wherein each cantilever beam comprises a contacting edge.

4. The connector of claim 3 wherein the contacting edge is straight.

5. The connector of claim 3 wherein the contacting edge is curved.

6. The connector of claim 1 wherein the engaging feature comprises a twistable bridge with a pair of flaps.

7. The connector of claim 1 wherein the engaging feature is disposed on one side of the opening.

8. The connector of claim 1 wherein the engaging feature is disposed on two opposite sides of the opening.

9. A plug side board-to-board connector comprising:
a plurality of plug contacts, each plug contact having a plug alignment feature configured to align each plug contact with a corresponding receptacle alignment feature of a receptacle side board-to-board connector.

10. The connector of claim 9 wherein the plug contact has a rectangular profile.

11. The connector of claim 9 wherein the plug contact has a profile containing a pair of curved edges on opposite sides of the plug contact and a pair of straight edges on opposite sides of the plug contact.

12. The connector of claim 9 wherein the plug contact further comprises beveled top corners.

13. The connector of claim 9 wherein each plug contact comprises a first plug structure and a second plug structure wherein the first plug structure has a different height than the second plug structure.

14. The connector of claim 9 wherein the plurality of plug contacts comprises a first plug contact and a second plug contact wherein the first and second plug contacts have different heights.
